(19) United States
(12) Patent Application Publication
(10) Pub. No.: US 2008/0203345 A1
(43) Pub. Date: Aug. 28, 2008

(54) CHOKE PLATE CONFIGURATION

(75) Inventor: Alan Wayne Burkhard, Fort Thomas, KY (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 12/035,342

(22) Filed: Feb. 21, 2008

Related U.S. Application Data
(60) Provisional application No. 60/891,431, filed on Feb. 23, 2007.

(51) Int. Cl. F16K 5/10

(52) U.S. Cl. 251/208; 137/601.16

(57) ABSTRACT

An orifice for use in a flow control valve, the orifice may include a fixed choke plate having at least one aperture therethrough for conducting fluids and a rotating choke plate having at least one aperture therethrough for conducting fluids. The rotating choke plate may be concentric with and disposed face-to-face with the fixed choke plate. Each of the apertures in the fixed choke plate and rotating choke plate include a rounded head section and a crescent tail section. Rotation of the rotating choke plate relative to the fixed choke plate varies an alignment of the fixed choke plate aperture and the rotating choke plate aperture.

### CROSS-REFERENCE TO RELATED APPLICATION

This application, pursuant to 35 U.S.C. §119(e), claims priority to U.S. Provisional Application Ser. No. 60/891,431, filed Feb. 23, 2007, the disclosure of which is hereby incorporated by reference.

### BACKGROUND OF DISCLOSURE

1. Field of the Disclosure

Embodiments disclosed herein relate generally to an orifice valve comprising a set of choke plates used for controlling the amount and direction of flow of various fluids.

2. Background

Orifice valves may be used to control the flow of fluids, such as fluids produced from oil and gas wells and the like. Orifice valves, for example, may be used for control of the rate of flow of well production fluids through a flow line.

The rate of flow through an orifice valve is determined, in part, by the number and size of apertures in both a stationary choke plate and a rotatable choke plate mounted across a fluid path in a valve body. The apertures in the rotatable choke plate are positioned in various degrees of alignment with holes in the stationary choke plate by angular movement of the rotatable choke plate. The rotatable choke plate may be moved from a fully closed position for blocking flow through the valve to a fully open position for providing maximum flow through the valve.

Drilling fluids typically contain abrasive materials, such as clay, silt, and sand particles, drill cuttings, drilling fluid additives, and the like. As a result, orifice valve components may erode due to the passage of abrasives through the valve. Erosion may result in a high frequency of valve replacement, which may be costly due to the high costs of drilling and any required down time to replace faulty valves.

A major portion of the erosion of orifice valves occurs when the orifice valve is only partly open. For example, erosion may be most significant when the valve is in a range of positions from being “cracked open,” i.e., just slightly open, to a position providing about 25% of the maximum flow through the valve.

When the valve is in this range of positions, a relatively high velocity fluid stream may be directed through apertures in the choke plates toward the wall of the valve body. As the high velocity stream impinges on the wall, it may cause rapid erosion. Abrasive fluids have been known, for example, to erode completely through the wall of an orifice valve in as little as several hours.

When the degree of erosion is severe, e.g., when the wall of a valve body has a hole formed in it from impingement of a fluid stream, oil well production must be stopped while the valve is replaced. Both the down time caused by valve replacement and the expense of the valves results in a significant increase in the cost of recovery of petroleum products.

Erosion may, in part, be avoided by providing orifice valves made in part of erosion-resistant materials. These materials may be ceramic materials or metals such as tungsten carbide and the like. However, even when erosion-resistant materials are used, the rate of erosion and resulting frequency of valve replacement is still much higher than desired.

Erosion may also, in part, be avoided by providing choke plates that minimize a radial component of fluids exiting the choke plates. Prior art orifice valves having multi-apertured choke plates include U.S. Pat. Nos. 3,331,396, 3,426,797, 3,414,007, 3,683,965, 4,360,040, 4,395,019, 4,431,028, 4,444,220, 5,080,128, and 6,945,264, for example.

Fluids in circulation may also contain large particles in addition to the small abrasive particles. Therefore, in addition to erosion resistant valves, orifice valves that may provide for a large flow area are desired. In many of the prior art multi-apertured choke valves, the multiple apertures restrict the amount of flow area that may be available for passage of large debris.

As examples of choke plates with restricted flow area, prior art choke plates are illustrated in FIGS. 1A-1C. FIG. 1A illustrates a choke plate configuration similar to that illustrated in FIG. 4A of U.S. Pat. No. 4,903,725, where 90 degrees of rotation will fully open both openings of the orifice. FIG. 1B illustrates a choke plate configuration similar to that illustrated in FIG. 8 of U.S. Pat. No. 5,054,521, again where 90 degrees of rotation fully opens the orifice. FIG. 1C illustrates a choke plate configuration similar to that illustrated in FIGS. 1-3 of U.S. Pat. No. 4,946,134, where 180 degrees of rotation will fully open the orifice; however, 120 degrees of flow area or less is presented in the fully open position. A less than optimal flow area is presented in each of these orifice configurations, and large debris may not be able to pass through the orifice.

Another example of a prior art choke plate is illustrated in FIG. 1D, having a D-shaped opening. The valve provides a large flow area, allowing for passage of sizeable debris, and requires 180 degrees of rotation to fully open the orifice. When cracked open, the D-shaped orifice may result in a concentrated flow, causing erosion of valve components. Due to erosion concerns, the solid portions of the choke plates, when new, may overlap by a linear distance A, such that the valve must be rotated to an angle α of 17 degrees or more prior to the valve reaching a cracked-open position. This overlap may provide for full closure of the valve after some wear, and may extend the service life of the valve, each at the expense of possible flow area.

The choke plates of FIGS. 1A-1D may also provide a roughly linear response when opening and closing. For example, for the quadrant-shaped portions of plates 1A, 1B and 1C, each successive degree of rotation results in approximately equal increases in the flow area.

Accordingly, there exists a need for an orifice flow control valve which requires a minimal frequency of replacement, resulting in less down time of well systems and improving economics of petroleum recovery. Additionally, there also exists a need for an orifice that maximizes the available flow area while minimizing wear. There also exists a need for an orifice valve having a non-linear flow response.

### SUMMARY OF THE DISCLOSURE

In one aspect, embodiments disclosed herein relate to an orifice for use in a flow control valve. The orifice may include a fixed choke plate having at least one aperture therethrough for conducting fluids, and a rotating choke plate having at least one aperture therethrough for conducting fluids, the rotating choke plate concentric with and disposed face-to-face with the fixed choke plate. Each of the apertures in the fixed choke plate and rotating choke plate include a rounded head section and a crescent tail section. Rotation of the rotating choke plate relative to the fixed choke plate varies an alignment of the fixed choke plate aperture and the rotating choke plate aperture.

In another aspect, embodiments disclosed herein relate to a flow control valve having a valve body, a downstream choke plate fixed to the valve body, an upstream choke plate concentric and in face-to-face engagement with the downstream choke plate, an upstream chamber in the valve body upstream from the upstream choke plate, a downstream chamber in the valve body downstream from the downstream choke plate, and a rotating member for rotating the upstream choke plate relative to the downstream choke plate between a closed position and an open position. The downstream choke plate may include at least one aperture in fluid communication with the downstream chamber. The upstream choke plate may include at least one aperture in fluid communication with the upstream chamber. The upstream and downstream apertures may have a rounded head section and a crescent tail section.

Other aspects and advantages will be apparent from the following description and the appended claims.

### BRIEF DESCRIPTION OF DRAWINGS

FIGS. 1A-1D illustrate prior art choke plate designs.

FIGS. 2A and 2B are schematic drawings of an orifice flow control valve according to embodiments disclosed herein.

FIGS. 3-6 illustrate choke plate designs, in various degrees of overlap, according to embodiments disclosed herein.

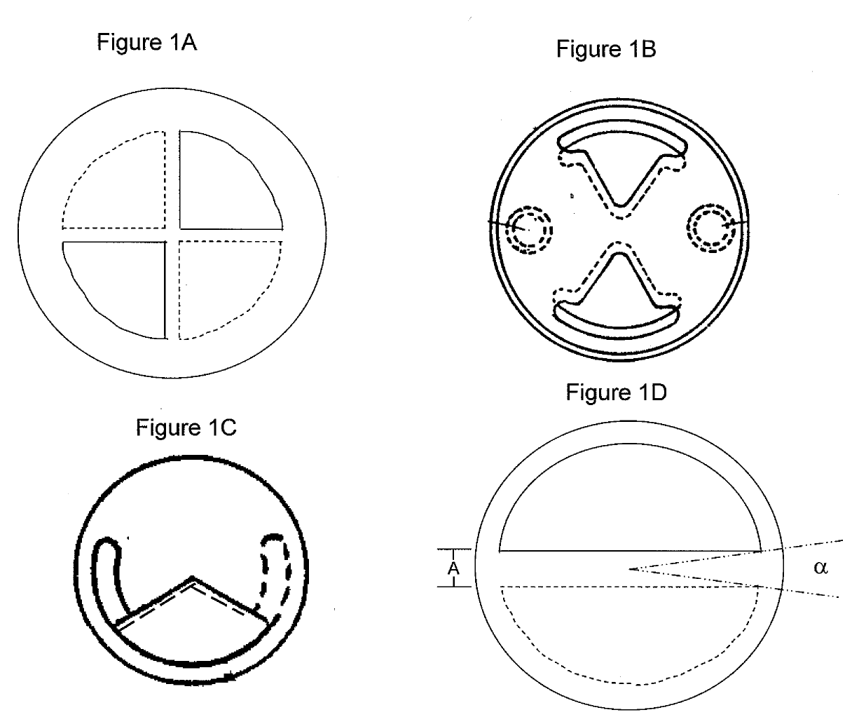

### DETAILED DESCRIPTION

In one aspect, embodiments disclosed herein relate to a variable orifice, where the orifice is formed from fixed and rotating choke plates including apertures having a rounded head section and a crescent tail section. In another aspect, embodiments disclosed herein relate to a flow control valve including fixed and rotating choke plates including apertures having a rounded head section and a crescent tail section. Apertures having a rounded head section and a crescent tail section may provide an extended flow area, reducing erosion of valve components, and may also provide for non-linear flow response.

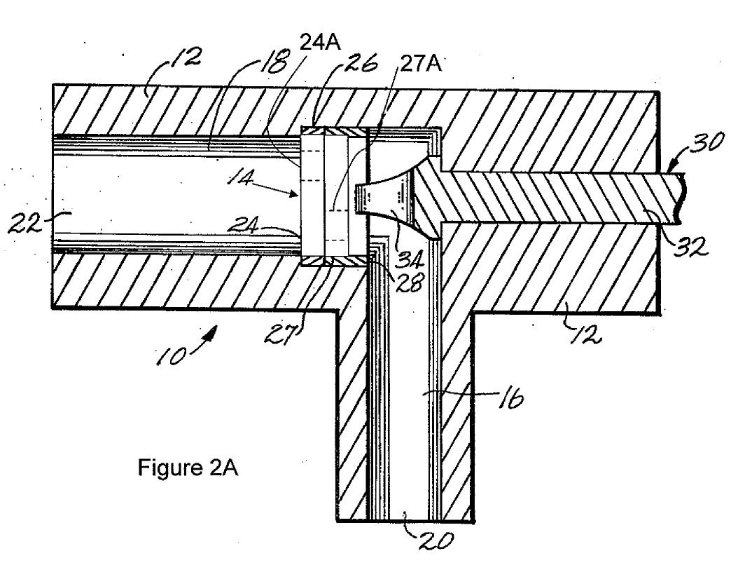

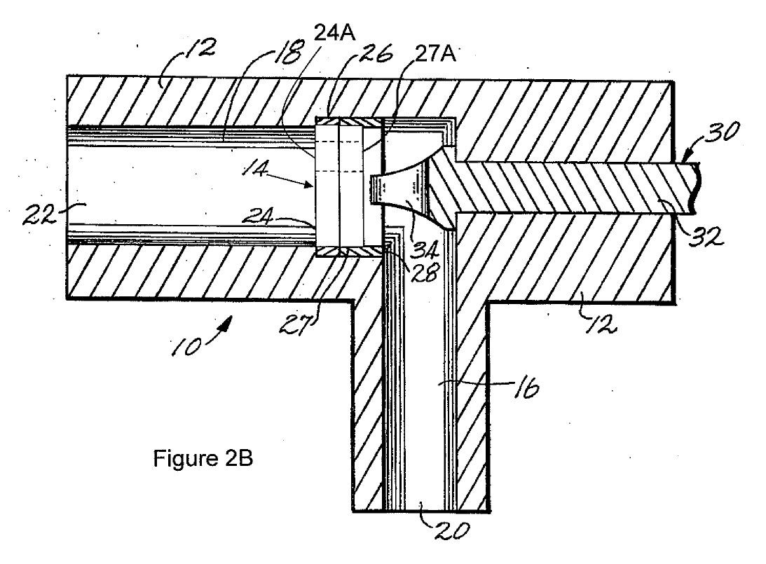

FIGS. 2A and 2B illustrate a simplified cross-sectional view of an orifice valve 10 according to embodiments disclosed herein. The orifice valve 10 may include a valve body 12 divided by a set of choke plates 14 into an upstream chamber 16 and a downstream chamber 18. An inlet opening 20 into the upstream chamber 16 may provide for entrance of fluids, and an outlet opening 22 from the downstream chamber 18 may provide for fluid egress. Although not shown in FIG. 2, suitable means for connecting the valve body to inlet and outlet conduits may be provided, including flanges, threads, or the like, at the inlet and outlet of the valve body.

The set of choke plates 14 may include a downstream choke plate 24 and an upstream choke plate 27, which may be formed from metals, ceramics, coated or surface treated metals, erosion resistant materials, and the like. Erosion resistant materials may include ceramics such as aluminum oxide or the like in some embodiments. In other embodiments, erosion resistant materials may include metal carbides, such as tungsten carbide, for example.

The downstream choke plate 24 and the upstream choke plate 27 may each include at least one aperture 24A, 27A, respectively. When the aperture 27A of the upstream choke plate 27 does not overlap the aperture 24A of the downstream choke plate 24A to any degree, i.e., when the apertures 24A, 27A are completely out of alignment with each other, as illustrated in FIG. 2A, fluid cannot flow from the upstream chamber 16 to the downstream chamber 18. When the apertures 24A, 27A are at least partly in alignment with each other, i.e., when portions of the apertures 24A, 27A are superimposed, as illustrated in FIG. 2B, fluid introduced into the upstream chamber 16 through the inlet 20 may flow through the overlapping portion of the apertures 24A, 27A in the choke plates 24, 27 into the downstream chamber 18 and exit the valve at the outlet 22. The amount of fluid flow through the valve 10 may be controlled by the degree of alignment of the apertures 24A, 27A.

In one embodiment, the downstream choke plate 24 may be mounted in a fixed position in the valve body 12 across the fluid flow path between the upstream and downstream chambers 16, 18. The downstream choke plate 24 may be mounted in an annular ring 26 which surrounds the circumference of the choke plate 24 and is affixed to the choke plate 24 by bonding with epoxy resin or other like adhesive materials and/or by other mechanical securing means such as pins. The ring 26, in turn, may be fixed by bolts, pins or the like to the valve body 12.

The upstream choke plate 27 may be rotatably mounted in the valve body 12 and may be concentric and in face-to-face engagement with the downstream choke plate 24. Each of the choke plates 24, 27 may have about equal radial and axial dimensions, although choke plates of differing dimensions may be used if desired.

The upstream choke plate 27 may be mounted in an annular ring 28 which surrounds the circumference of the choke plate 27. The upstream choke plate 27 may be rotated relative to the downstream choke plate 24 for superimposing aperture 27A in the upstream choke plate 27 in various degrees of overlap or alignment with aperture 24A in the downstream choke plate 24. The choke plates 24, 27 may be flat and the facing surfaces may be smooth to provide ease of movement of the choke plates 24, 27 relative to each other and to provide a seal when the valve 10 is closed.

Rotation of the upstream choke plate 27 may be effected by a turning member 30 mounted in the valve body 12. The turning member 30 may include a valve stem 32 passing through an opening at one end of the valve body 12. The valve stem 32 may be sealed to prevent passage of fluids between valve stem 32 and the valve body 12, where the seals (not shown) may include o-rings or the like. Valve stem 32 may provide a means for rotating the annular ring 28. For example, connection 34 may be provided on the end of valve stem 32, where connection 34 engages annular ring 28 holding the upstream choke plate 27. When valve stem 32 is rotated, connection 34 causes rotation of the ring 28 which, in turn, provides rotation of the upstream choke plate 27.

With regard to prior art orifice valves, as described above, valves may experience erosion problems when apertures in an upstream and downstream choke plate are not fully in alignment and erosive materials are present. As fluids pass through the apertures, there may be a resultant non-axial force on the fluid stream which may direct the stream exiting the orifice with at least some radial component of motion. Impingement of a radially directed stream on the wall of a valve body may result in erosion, as described above.

In contrast to prior art orifice valves that produce a concentrated stream when cracked open, embodiments disclosed herein may provide a set of choke plates that produce a sheet-like flow, dispersing the stream energy over a broader area. The dispersed stream, with less focused energy, may result in decreased erosion. In some embodiments, the flow area provided by the overlapping apertures may be curved, causing portions of the fluid flow exiting the overlapping apertures to impinge or otherwise interact in the downstream chamber, negating radial flow components and further reducing erosive properties of the fluid. Additionally, when the valve is at least partially open or in a fully open position, the apertures may provide a generally axially directed fluid stream in the downstream chamber 18.

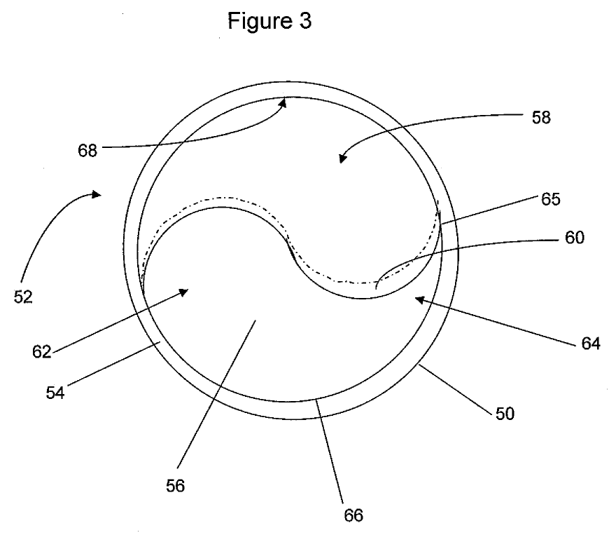

The set of choke plates disclosed herein, providing a sheet-like flow when cracked open, may be more fully understood by referring to FIGS. 3 through 6. The choke plates are shown as viewed from the upstream chamber toward the downstream chamber. For clarity of illustration, the valve body is not shown. The choke plates may be contiguous and mounted coaxially in face-to-face engagement. Apertures in both choke plates are shown in various degrees of alignments relative to each other in FIGS. 3-6.

Referring to FIG. 3, a set of choke plates is illustrated in a fully closed position, where the apertures in the choke plates are not in alignment to any degree. The upstream choke plate 50 and the downstream choke plate 52 may each include a circumferential support area 54. The upstream choke plate aperture 56 and the downstream choke plate aperture 58 do not overlap. In the fully closed position, a solid portion of the upstream choke plate 50 overlaps a solid portion of the downstream choke plate 52, as shown by the area 60 between the solid and dashed sigmoidal lines representing the bounds of the apertures 56, 58.

The apertures 56, 58 in the upstream and downstream choke plates 50, 52 may include a rounded head section 62 and a crescent tail section 64. In some embodiments, the apertures 56, 58 having a rounded head section and a crescent tail section may be tear drop shaped or curved tear drop shaped. The apertures 56, 58 in the upstream and downstream choke plates 50, 52 are aligned in a head-to-tail arrangement, providing the maximum possible flow area when the apertures 56, 58 are fully aligned.

In some embodiments, the crescent tail section 64 may terminate in a v-shaped point 65, as illustrated in FIG. 3. In other embodiments, the crescent tail section 64 may have a rounded (u-shaped or c-shaped) end. In other embodiments, the crescent tail section may be squared-off.

In some embodiments, the apertures having a rounded head section and a crescent tail section may resemble half of a “yin-yang” symbol. To provide overlapping solid portions between the choke plates, in some embodiments, a yin-shaped solid area of a plate may encompass more area than a yang-shaped aperture through the plate. In this manner, the solid areas of two facing plates may overlap when the apertures are not superimposed, allowing for full closure of the valve. In other embodiments, the apertures having a rounded head section and a crescent tail section may resemble a lacy tear drop, a droplet shaped vegetal, or a paisley design. In yet other embodiments, the apertures having a rounded head section and a crescent tail section may resemble an aerofoil or a rounded aerofoil.

Still referring to FIG. 3, the outer circumference 66 of the aperture 56 should be at approximately the same radial distance as the outer circumference 68 of the aperture 58. Similarly, the inner bounds of the apertures 56, 58 should substantially or completely overlap when the apertures are aligned. In some embodiments, the apertures 56, 58 may be completely superimposable.

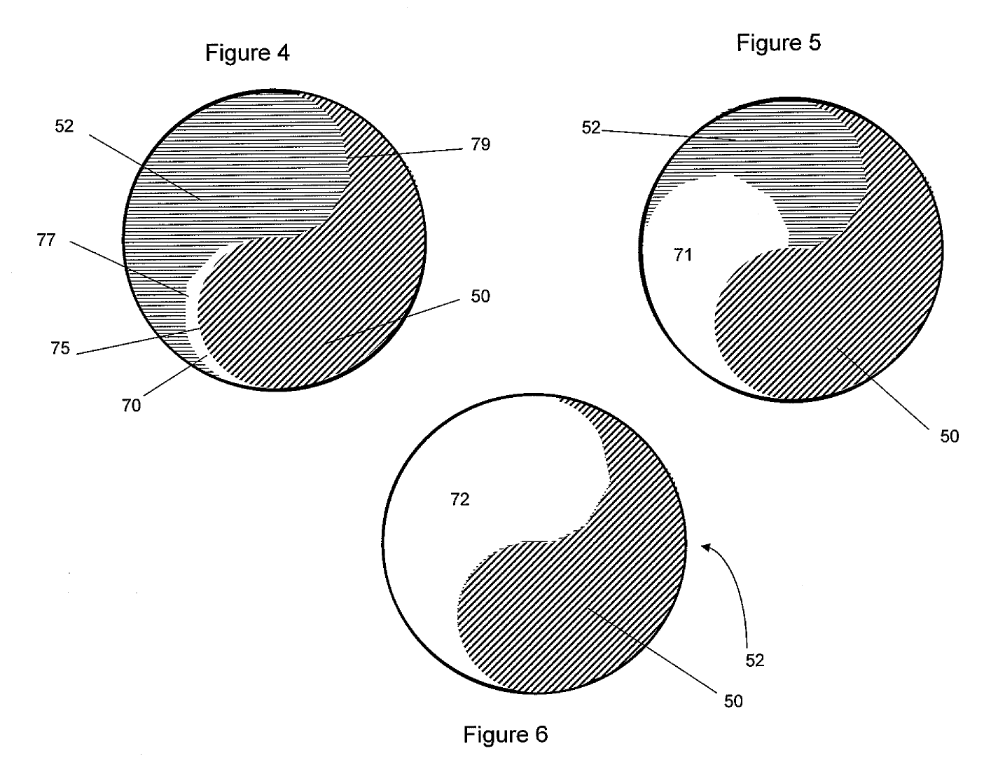

Referring to FIGS. 4-6, the choke plates 50, 52 are shown after the upstream choke plate 50 has been rotated to varying degrees. In FIG. 4, the upstream choke plate 50 has been rotated such that the apertures in the upstream and downstream choke plates 50, 52 are only slightly superimposed, exposing a flow area 70. This may be considered a “cracked-open” position because only a small portion of the aperture in the downstream choke plate 52 is in alignment with the aperture in the upstream choke plate 50. In FIG. 5, the upstream choke plate 50 has been rotated to roughly a half-open position, exposing a much larger flow area 71.

In FIG. 6, the upstream choke plate 50 has been rotated to a full-open position, exposing the total available flow area 72. The total available flow area, in some embodiments, may be large enough to pass rocks and debris that may be encountered in some drilling fluid environments.

Referring again to FIG. 4, even at a cracked-open position, the matching curvature of the apertures may provide an elongated flow area. As described above, erosion may occur primarily when the valve is in a cracked-open position. Compared to prior art orifice plates that create jets or concentrated streams of fluid when at a cracked-open position, the elongated flow area provided by the aperture s described herein may provide a sheet-like flow dispersing the fluid flow over a greater area, thus decreasing the amount of wear that the valve may experience at minimal openings. As the valve is opened further, axial flow may dominate, lessening concerns about erosion.

In some embodiments, the curvature of the flow area 70 provided by the overlapping apertures may cause portions of the fluid flow exiting the overlapping apertures to impinge or otherwise interact in the downstream chamber, negating radial flow components and further reducing erosive properties of the fluid. For example, the curvature proximate the outer diameter of the opening may introduce a negative radial component to a portion of the elongated flow stream, whereas the curvature proximate the inner portion of the opening may introduce a positive radial component to a portion of the elongated flow stream. In some embodiments, the radial components may cause impingement of portions of the elongated flow stream, further reducing erosion.

By providing apertures as shown, it can be seen that during the valve's full range of travel from a fully closed to a fully open position, fluid will not be directed with substantial force against the wall of the valve body. The flow stream that is directed toward the valve body is elongated, spreading the erosive force over a larger area. Thus, erosion of the valve body may be reduced in certain embodiments.

In some embodiments, prior to any wear on the valve, an overlap of solid portions of the choke plates, to provide full closure (such as overlap area 60 shown in FIG. 3), may be uniform across the valve. As the elongated flow area provides for a less concentrated wear area on the choke plates, the service life of the choke plate may be extended as compared to prior art choke plates. In other embodiments, the overlap area may be reduced as compared to prior art valves, providing both extended service life and a larger flow area for passage of rocks and debris.

Referring again to FIG. 4, when the valve is open to any degree, fluid flow is always present at the leading edges 75, 77 of the apertures surrounding flow area 70.

Other portions of the apertures, such as trailing edge 79 of upstream choke plate 50 may not experience erosive flow except when the valve is partially or fully opened. Thus, the leading edges 75, 77 of the apertures may encounter more wear than other portions of the apertures, such as trailing edge 79. In some embodiments, prior to any wear on the valve, the overlap of the solid portions of the choke plates, when the valve is closed, may be greater proximate the leading edge than proximate the trailing edge. For example, referring to FIG. 3, the overlap 60 proximate the head section 62 may be greater than an overlap 60 proximate the tail section 64. A greater overlap of solid portions proximate the leading edge may allow for extended valve service life before fill closure cannot be attained, and may also allow for a greater flow area due to the decreased overlap of solid portions proximate the trailing edge.

In some embodiments, an overlap of the fixed choke plate solid portion with the rotating choke plate solid portion, when the valve is in a fully closed position, may be equal to or less than 0.25 inches. In other embodiments, the overlap may be equal to or less than 0.1875 inches; equal to or less than 0.125 inches in other embodiments; equal to or less than 0.0625 inches in other embodiments; equal to or less than 0.03125 inches in other embodiments; and equal to or less than 0.015625 inches in yet other embodiments.

In some embodiments, prior to any wear on the choke plates, the rotating choke plate may require a rotation equal to or less than 15 degrees to traverse from a fully closed position to a cracked-open position. In other embodiments, the rotating choke plate may require a rotation equal to or less than 13 degrees or less to traverse from a fully closed position to a cracked-open position; equal to or less than 10 degrees in other embodiments; equal to or less than 8 degrees in other embodiments; and equal to or less than 5 degrees in yet other embodiments.

The amount and shape of the full-closure overlap area as well as the relative manner in which the rounded head section of the upstream choke plate superimposes on the tail section of the downstream choke plate during opening may be used to effect a desired flow response in the valve. In some embodiments, the apertures disclosed herein may provide for a non-linear flow response.

Advantageously, embodiments disclosed herein may provide an orifice flow control valve that includes a large flow area for passage of rocks and debris. The apertures having a rounded head section and a crescent tail section may provide for an elongated flow area, even at a cracked-open position, thus decreasing the amount of wear that may be experienced by downstream components of the valve. Additionally, the elongated flow area may spread the wear experienced by the choke plate assembly over a larger wear surface, providing for an extended service life of the choke plates. Since the initial opening of the choke plates provides a curved surface, the fluid (including drilling fluid or mud) may exit the choke plates as a sheet instead of a concentrated stream, thereby reducing wear on both the choke plates and the valve components.

While the present disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. An orifice for use in a flow control valve, comprising:
a fixed choke plate having at least one aperture therethrough for conducting fluids; and
a rotating choke plate having at least one aperture therethrough for conducting fluids, the rotating choke plate concentric with and disposed face-to-face with the fixed choke plate;
wherein each of the apertures in the fixed choke plate and rotating choke plate comprises a rounded head section and a crescent tail section; and
wherein rotation of the rotating choke plate relative to the fixed choke plate varies an alignment of the fixed choke plate aperture and the rotating choke plate aperture.

2. The orifice of claim 1, wherein the apertures comprising a rounded head section and a crescent tail section comprise half of a yin-yang design.

3. The orifice of claim 1, wherein the apertures comprising a rounded head section and a crescent tail section comprise a paisley design.

4. The orifice of claim 1, wherein the apertures comprising a rounded head section and a crescent tail section comprise an aerofoil design.

5. The orifice of claim 1, wherein, when the orifice is in a closed position, the aperture in the fixed choke plate is in a head-to-tail arrangement with the aperture in the rotating choke plate.

6. The orifice of claim 1, wherein, when the orifice is in a closed position, an overlap of a fixed choke plate solid portion with a rotating choke plate solid portion is equal to or less than 0.25 inches.

7. The orifice of claim 6, wherein the overlap is equal to or less than 0.125 inches.

8. The orifice of claim 6, wherein the overlap proximate a leading edge of the rotating choke plate aperture is greater than the overlap proximate a trailing edge of the rotating choke plate aperture.

9. A flow control valve, comprising:
a valve body,
a downstream choke plate fixed to the valve body;
an upstream choke plate concentric and in face-to-face engagement with the downstream choke plate;
an upstream chamber in the valve body upstream from the upstream choke plate;
a downstream chamber in the valve body downstream from the downstream choke plate;
a rotating member for rotating the upstream choke plate relative to the downstream choke plate between a closed position and an open position; and
wherein the downstream choke plate comprises at least one aperture in fluid communication with the downstream chamber;
wherein the upstream choke plate comprises at least one aperture in fluid communication with the upstream chamber;
wherein the upstream and downstream apertures comprise a rounded head section and a crescent tail section.

10. The valve of claim 9, wherein the apertures comprising a rounded head section and a crescent tail section comprise half of a yin-yang design.

11. The valve of claim 9, wherein the apertures comprising a rounded head section and a crescent tail section comprises a paisley design.

12. The valve of clam 9, wherein the apertures comprising a rounded head section and a crescent tail section comprises an aerofoil design.

13. The valve of claim 9, wherein when the valve is in a closed position, the aperture in the fixed choke plate is in a head-to-tail arrangement with the aperture in the rotating choke plate.

14. The valve of claim 9, wherein, when the valve is in a closed position, an overlap of a fixed choke plate solid portion with a rotating choke plate solid portion is equal to or less than 0.25 inches.

15. The valve of claim 14, wherein the overlap is equal to or less than 0.125 inches.

16. The valve of claim 14, wherein the overlap proximate a leading edge of the rotating choke plate aperture is greater than the overlap proximate a trailing edge of the rotating choke plate aperture.
